(19) United States
(12) Patent Application Publication
(10) Pub. No.: US 2001/0005370 A1
(43) Pub. Date: Jun. 28, 2001

(54) Label distribution repeating installation and label distribution repeating method

(76) Inventor: Hiroshi Ueno, Tokyo (JP)

Correspondence Address: Whitham, Curtis & Whitham, Reston International Center, Suite 900, 11800 Sunrise Valley Dr., Reston, VA, 20191, US

(21) Appl. No.: 09/746,229

(22) Filed: Dec. 26, 2000

(30) Foreign Application Priority Data
Dec. 28, 1999 (JP) 372169/1999

(51) Int. Cl. H04L 12/28; H04L 12/56

(52) U.S. Cl. 370/393; 370/401; 370/410; 370/469

(57) ABSTRACT

A label distribution repeating installation and it's method which enables to make a label allocating process more efficient in a switching node that mounts a label distribution protocol. A label distribution repeating installation of the present invention includes line termination equipment for terminating a packet transmitted to take out packet data and perform a transmission process, and a repeating processor for performing a repeating transfer process of the packet from the packet data acquired from the line termination equipment, the repeating processor comprising a protocol data unit (PDU) receiver for disassembling the packet data into message elements of the label distribution protocol, a protocol analyzer for analyzing a message required for repeating from each message element, a PDU transmitter for assembling the packet data to be retransmitted in accordance with the analysis of the message elements, and a label correspondence table for storing LDP message information received.

### BACKGROUND OF THE INVENTION

1. Field of the Invention

The present invention relates to a label distribution repeating installation and a label distribution repeating method for repeating a label distribution protocol, and increasing efficiency of a label allocating process using a label correspondence table that stores label information between adjacent nodes.

2. Description of the Prior Art

In recent years, the IETF (Internet Engineering Task Force) has considered standardizing a multi-protocol label switching (MPLS) transfer method as one of the IP traffic transfer methods.

The multi-protocol label switching means a switching method for effecting the fast transfer by separating a transfer process of each packet and a path calculation process on a connection type network, such as an ATM (Asynchronous Transfer Mode), and a technique for omitting the transfer process of IP layer for each packet by allocating a fixed-length label to a packet flow identified on the basis of the transfer information of Layer 3, and transferring it on the basis of the label. Also, the protocol of transport layer can cope with various protocols such as ATM, Frame Relay, and Ethernet.

In the label switching method, a connection set between the nodes is established in accordance with the path information as to the address in the network layer, a transfer process within a network for the established connection is identified not by the address information of the IP packet, but by a “label”. A switch within the network that has received a packet having an indication of label transfers the packet on the basis of the label.

Once a label is allocated to each node in accordance with the path information, a path calculation process of Layer 3 is unnecessary for each received packet in the packet transfer process. If the path information is changed, a new label is allocated. In this way, at a repeating node, there is no need of performing the path calculation process by referring to the packet information of the network layer. Hence, the fast transfer of packets is effected by transmitting packets to a transfer destination corresponding to the label of received packet.

The allocation of a label for the node located on the path of packet flow is made on the basis of a destination IP address for the IP packet received, when the node at the entrance of network starts the label allocation process. As one of the label allocation methods, an LDP (Label Distribution Protocol) is controversial. The LDP is a protocol instituted by the IETF MPLS work committee, and for allocating a label for use to transfer the packet data to the destination of a desired IP address between the label switching routers.

A label allocation method using this LDP involves distributing a label by establishing a TCP connection for LDP communication between adjacent routers and exchanging a message.

A concept of the label switching operation will be described below. At an edge router located at the subscriber side of a network, if an IP packet is received from the subscriber, the IP address and other attribute information are read from the header information of the IP packet. And for a packet flow to which this packet belongs, an output port and an output label are determined, and a label allocation request is transferred to a next stage node, using an LDP message.

At a node that has received the label allocation request, an input port of the packet flow, and an output port and an output label corresponding to the input label information are determined, the determined information being passed to the previous stage node. Further a label allocation request message is transmitted to a latter stage node. And the determined label information is registered in a label conversion table. This operation is repeated between adjacent nodes. In all the nodes on the path from an entrance node to an exit node in a certain network, the label conversion information is determined and registered. And at the entrance node, the transfer process within the network is performed on the basis of the label information appended to each IP packet belonging to the packet flow.

The operation of a message exchange method with the LDP will be exemplified below. FIG. 8 is an explanatory view illustrating an example of a label distribution procedure of the conventional method.

An upstream router 201 and a downstream router 202 in a data transfer direction exchange an LDP message by setting up a TCP connection for label distribution protocol communication, as shown in FIG. 8.

In the conventional label distribution procedure, the upstream router 201 designates a transfer class (FEC; Forwarding Equivalence Class), and transmits a Label Request message to the downstream router 202. Herein, the transfer class signifies a parameter for designating the destination to which the packet is transferred, such as an IP address, an IP network address and so on. In an instance of FIG. 8, a Label Request message is transmitted to the router 202, with the IP address 1.1.1.0 and the net mask value 24 specified.

The downstream router 202 receives the Label Request message, and then examines the validity of a designated parameter contained in the message, allocating a label to the specified transfer class.

Then, the router 202 reports an allocated label value to the upstream router 201, with a Label Mapping message containing the label information allocated. In the instance of FIG. 8, the router 202 responds with a Label Mapping message indicating that a label 10 is allocated to FEC value=1.1.1.0/24 to the router 201. Herein, a net mask value is used to specify a group of IP addresses. For the address specification of the IPv4 having an address space of 32 bits, the address is specified by a positive numerical value to designate an address group having a destination at arbitrary IP address belonging to a sub-network from 1.1.1.1 to 1.1.1.255.

Thus, in the present LDP standard specifications, the allocation of a label and the exchange of the allocated label information are performed between adjacent routers, a one-to-one communication connection is established end-to-end from an entrance node to an exit node.

The transfer operation after setting the label will be described below briefly. In a communication node such as an edge router that is located at an entrance of the network, as shown in FIG. 9A, an output port and an output label are determined from the destination address information of the received IP packet at Layer 3. As shown in FIG. 9B, the predetermined label information is appended to a packet to be transferred within the network, and the packet is transmitted. In a communication node within the network connected to the net stage, for example, a core router, an output port and an output label are determined by only referring to the label information of the received packet, and the packet is transferred.

FIGS. 10A, 10B exemplifies a correspondence table provided in this edge router and a label conversion table provided in the core router.

The methods of receiving a label allocation request from the label switching router, allocating a label to a requested router for connection, and replying with the allocated label to a requester have been disclosed in Japanese Patent Laid-Open No. 11-041253 and Japanese Patent Laid-Open No. 11-243416.

The invention concerning the switching router as described in Japanese Patent Laid-Open No. 11-041253 relates to a label switching router comprising a data repeating controller for controlling the transfer of IP datagram and an ATM switch, and the ATM switch for switching an ATM cell, wherein while an operation state of the data repeating controller is monitored, the ATM switch is set to a VP path by user specification in accordance with a failsafe path table internally provided. In this way, even if there is a failure in the data repeating controller, the communication via this ATM switch is maintained.

The invention concerning a loop detecting method of the node unit and the label switching path as described in Japanese Patent Laid-Open No.11-243416 relates to anode unit for performing the label switching of an input packet, which stories a flow identifier that can identify uniquely a packet flow and the information as to the first stage node to form a loop of the label switching path on the basis of a label allocating request message for requesting the setting of a label switching path that has been received from a former stage node unit, wherein when a request message with the same contents as the label allocating request message is received from a different node from the former stage node unit, the formation of loop is determined.

### BRIEF SUMMARY OF THE INVENTION

Object of the Invention

However, with an MPLS technique as described above, ATM, a frame relay, PPP, or Ethernet is available as the transport layer. In the case of a media sharing type LAN, such as Ethernet, it is expected that a number of label switching routers are possibly connected to the LAN. And in this case, since there are more adjacent routers, the problem may arise that the number of connections for the LDP communication increases.

In the conventional method, a logical connection between routers is established one to one, and an LDP protocol process for each connection is conducted to make the label distribution (request/allocation). In the case where there are many communication nodes contained within a network, the overhead in the LDP protocol process may increase and the management of the label information may be complicated. Such a load will appear remarkably, particularly in the media sharing type LAN, and give rise to congestion of the whole LAN, resulting in slow processing response or the missing data.

The present invention has been achieved in the light of the above-mentioned problems, and an object of the invention is to provide a label distribution repeating installation for effecting the label allocating process in a network for making the transfer of packets using a label switching method.

### SUMMARY OF THE INVENTION

A label distribution repeating installation of the present invention provides a message repeating function of repeating a connection with a router to which each router should establish a session, and an agent allocation function of caching the allocation table information for the already allocated label.

The present invention provides a label distribution repeating installation for repeating the transfer of label information between communication nodes for effecting the label switching of an input packet in such a manner as to detect a packet flow to be grouped by a packet group having the same attribute received from a transmission path, and append an identifiable label to the packet flow, the label distribution repeating installation comprising:

means for receiving a label allocation request message from a former stage communication node, and then taking out the destination information from the request message to repeat the transfer of destination information to an allocated communication node;

means for receiving a label allocating response from the allocated communication node, and storing the label allocating response as the label corresponding information for each destination information; and

means for receiving a label allocation request message that is self-allocable from the label corresponding information, and then performing a label allocating process directly to respond to a requesting communication node.

Also, a label distribution repeating installation of the invention comprises line termination equipment for terminating a packet to be transmitted to take out the packet data and make a transmission process, and a repeating processor for performing a repeating transfer process of the packet from the packet data acquired from the line termination equipment, wherein the repeating processor further comprises a protocol data unit (PDU) receiver for disassembling the packet data into the message elements of a label distribution protocol, a protocol analyzer for analyzing a message required for repeating from each message element, a PDU transmitter for assembling the data to be retransmitted in accordance with the analysis of the message elements, and a label correspondence table for storing the LDP message information that has been received.

### BRIEF DESCRIPTION OF THE DRAWINGS

This above-mentioned and other objects, features and advantages of this invention will become more apparent by reference to the following detailed description of the invention taken in conjunction with the accompanying drawings, wherein:

FIG. 1 is a functional block diagram of a label distribution repeating installation according to one embodiment of the present invention;

FIG. 2 is a network configuration diagram including the label distribution repeating installation according to the embodiment of the invention;

FIG. 3 shows an example of a label correspondence table according to the embodiment of the invention;

FIG. 4 shows a packet format of a label distribution protocol;

FIG. 5 shows an example of a label distribution procedure according to the embodiment of the invention;

FIG. 6 shows another example of a label distribution procedure according to the embodiment of the invention;

FIG. 7 shows an example of a label release operation according to the embodiment of the invention;

FIG. 8 is an explanatory view exemplifying a label distribution procedure of the conventional method;

FIG. 9A is an explanatory view showing a packet transfer concept in the label switching of the conventional method;

FIG. 9B is an explanatory view showing a packet format Which the predetermined label information is appended;

FIG. 10A exemplifies a correspondence table provided in this edge router;

FIG. 10B exemplifies a label conversion table provided in the core router; and

FIG. 11 is an explanatory view for explaining the label merge operation according to the embodiment of the invention.

### DETAILED DESCRIPTION OF THE PREFERRED EMBODIMENTS

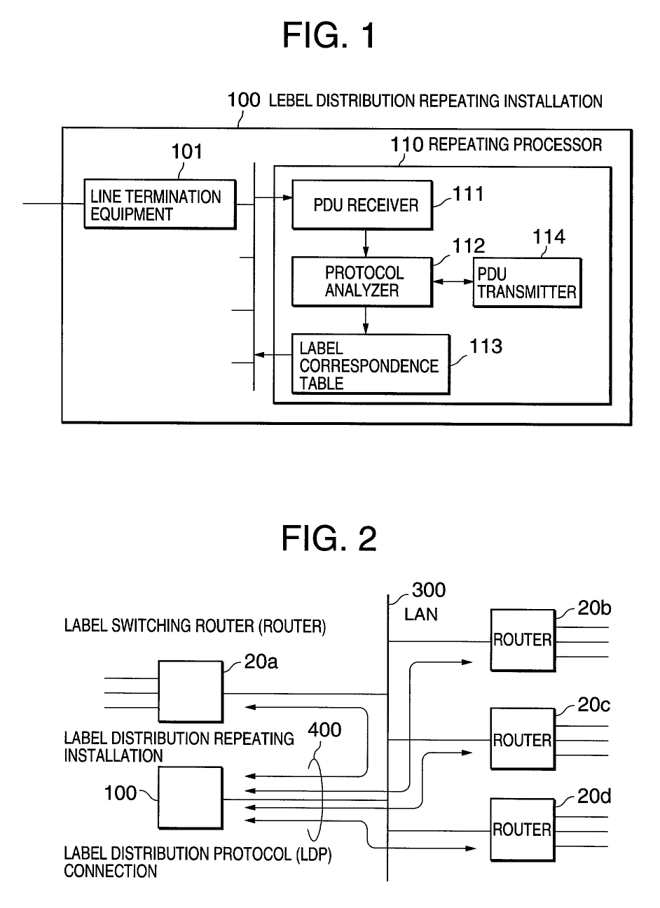

The preferred embodiments of the present invention will be schematically described below. FIG. 1 is a functional block diagram of a label distribution repeating installation according to one embodiment of the invention. The label distribution repeating installation 100 receives a label allocation request message from a label switching router, then takes out a destination LDP identifier and the transfer class (FEC) information from the request message, and transfers the request information to the corresponding router, as well as storing the request information in a table.

And for a packet flow having the same transfer destination as the transfer destination with an already set label, the label distribution repeating installation 100 performs the allocation by itself, and notifies the allocation information to an associated router, when the same label can be allocated. The destination LDP identifier as used herein is one for identifying the interface of a transfer destination node to send a message using an LDP protocol. The label allocating information is held in a label correspondence table 114, and a label allocation request message that is allocable by itself is not transferred to the downstream router, but replied to a requesting router, decreasing the allocation load of the downstream router.

If such a label allocation control is performed, it is possible to decrease the number of connections in the label distribution protocol between routers in a network for effecting the label switching, or particularly, in a LAN media, and reduce the processing load of each router.

In this invention, if a packet distribution repeating installation is defined in such label distribution protocol, the conventional management of individual connections that are set by the FEC in accordance with the LDP is omitted, and means for reducing the processing load of each router is provided.

The device configuration of the label distribution repeating installation of this invention will be described below. The label distribution repeating installation as shown in FIG. 1 comprises the line termination equipment 101 and a repeating processor 110, the repeating processor 110 comprising a PDU (Protocol Data Unit) receiver 111, a protocol analyzer 112, a PDU transmitter 113, and a label correspondence table 114.

The line termination equipment 101 terminates a packet from a LAN circuit such as Ethernet, and passes the data to the PDU receiver 111. The PDU receiver 111 disassembles the data into message elements of the label distribution protocol. The protocol analyzer 112 retrieves a message required for repeating from the messages. Also, it retrieves the destination router information of message from a destination LDP identifier message, and determines to which router the message is transferred.

Also, a transfer class information element and a label number that indicate a destination network address are taken out of a label map message, and registered in the label correspondence table 114. If the message analysis is ended, a message to be retransmitted is sent to the PDU transmitter 113 to assemble the message into PDU, which is then transmitted to the router from the line termination equipment 101.

FIG. 2 shows an arrangement of the label distribution repeating installation 100 within a network. FIG. 2 is a configuration diagram of the network including the label distribution repeating installation. First, an application example of the media sharing type LAN such as Ethernet will be described below.

The label distribution repeating installation 100 of this invention is arranged in a local area network (LAN) 300 to which a plurality of label switching routers 200 are connected. Between each label switching router (20a, 20b, 20c, 20d) and the label distribution repeating installation 100, a multiplicity of communication connections 400 for transferring a label distribution protocol (LDP) are set up. One of these communication connections is set between each router and the label distribution repeating installation.

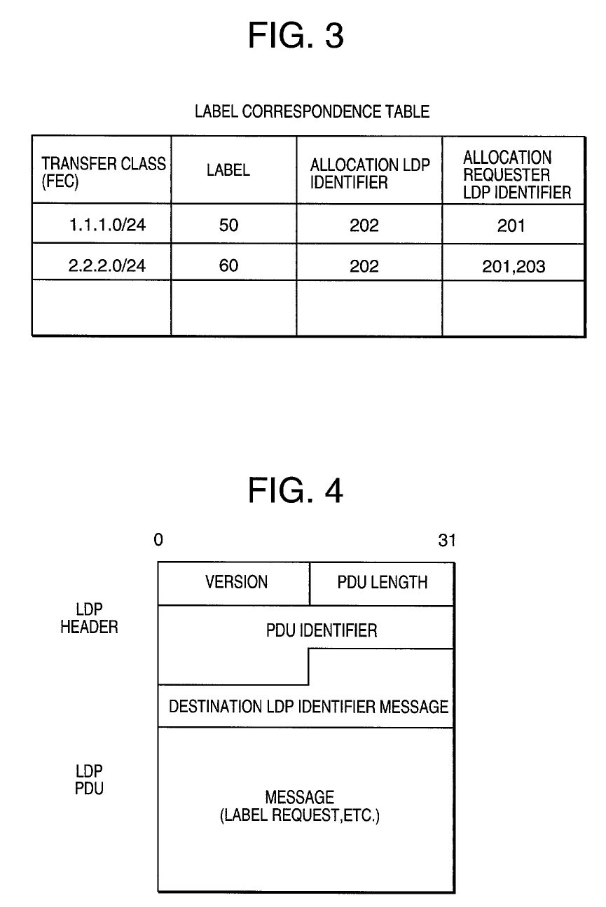

FIG. 3 shows the contents of the label correspondence table 114 of this invention. FIG. 3 shows one example of the label correspondence table in the embodiment of the invention. The label correspondence table 114 contains the information as to which label value is allocated to each transfer class information element (FEC), the LDP identifier (LDP ID) of the router that has allocated the label, and the LDP ID of the router that has requested its allocation.

In this example of FIG. 3, when the destination (FEC) with a net mask of 24 bits at an IP network address 1.1.1.0 is concerned, a label 50 is used for the transfer from a router 201 to a router 202. When the destination (FEC) with a net mask of 24 bits at an IP network address 2.2.2.0 is concerned, a label 60 is used for the transfer from a router 201, 203 to a router 202. That is, in the case where the same FEC is used between adjacent routers, the same label is allocated to make the management of label information more efficient.

The present invention has the feature in that a packet of the label distribution protocol (LDP) includes not only the conventional LDP ID value of the allocation requester, but also the LDP ID information of the allocated router.

FIG. 4 shows a format of a label distribution protocol packet. An LDP packet is composed of an LDP header and an LDP PDU section. The LDP header includes the version number, the PDU data length, and the LDP identifier of the message originator. The LDP PDU includes a plurality of messages, an identifier being assigned to each message. With a label distribution method of the invention, for this message, a new message referred to as a destination LDP identifier message is defined and used to designate the transmission address.

The operation of this embodiment of the invention will be described below. The label distribution repeating installation 100 as shown in FIG. 2 has a label distribution protocol connection 400 established with each label switching router 200 in an operating state. More specifically, a communication path of the connection type on the IP referred to as TCP is formed to secure a protocol communication path to each router. And the label distribution repeating installation 100 handles a label distribution protocol (LDP) packet to be passed on the protocol communication path to each router.

The label distribution repeating installation 100 receives a signal from each router in the line termination equipment 101, performs an IP terminating process and a TCP terminating process, and then takes out an LDP packet as shown in FIG. 4. In the LDP packet, the LDP header contains an LDP identifier of the transmission source as the standards. The LDP PDU section contains a plurality of messages, but a destination LDP ID message that is not standardized in the invention is defined. In the destination LDP ID message defined in the embodiment of the invention, there is described an LDP identifier of the router to send the LDP packet.

The label distribution repeating installation retrieves this LDP identifier from a received message to recognize a router of repeating destination. The repeating operation of LDP packets in this repeating installation will be described below in detail.

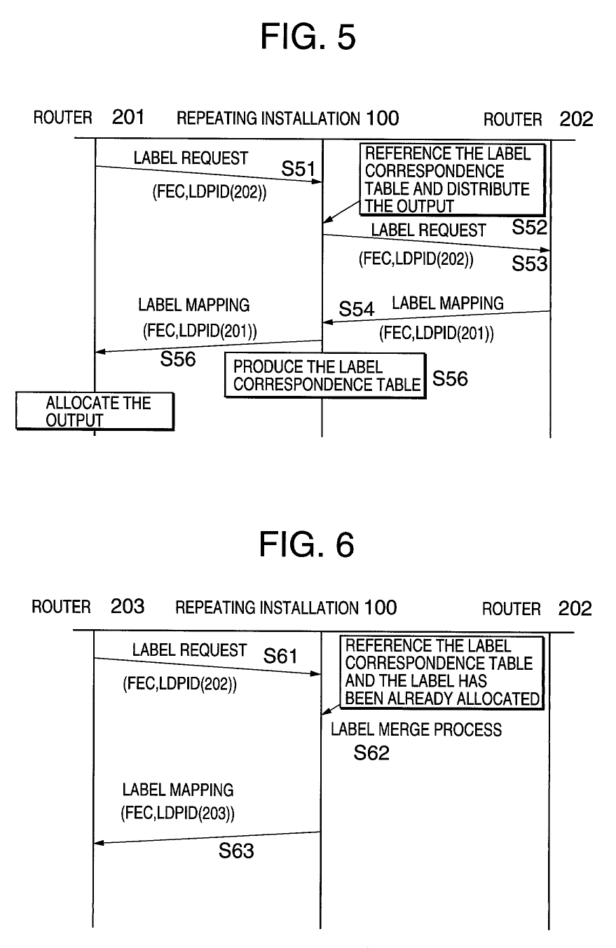

FIG. 5 shows an example of a label distribution procedure in this embodiment of the invention. The label allocation operation will be described below with reference to FIG. 5.

(1) Initial operation for label allocation

A case will be considered in which the upstream router 201 makes a new label allocation request to the downstream router 202. At this time, the upstream router makes a label allocation request for communication to the repeating installation 100. Using a message referred to as Label Request message, the network address of the transfer class (FEC) to request the label allocation is specified. Also, the destination LDP identifier message has described an LDP identifier of the router requesting for the label allocation, and then is sent (step S51).

The repeating installation 100 disassembles the data into messages in the PDU receiver 111 to recognize a Label Request message, and retrieves the LDP identifier of destination router from the LDP identifier of message transmitting source and the destination LDP identifier message contained in the LDP header.

The protocol analyzer 112 references the label correspondence table 114, using the transfer class information (FEC) and the destination LDP identifier acquired from the messages, and determines whether or not a label is already allocated to this FEC from the destination LDP identifier (step S52).

As a result of reference, in the case where no entry is found, an allocating request is transmitted to the router 202. The allocating request is specified as the request to the router 202 from the destination LDP identifier, and a Label Request message is transmitted to a communication connection established between the router 202 and the repeating installation. The LDP identifier in the LDP header of this LDP packet is written identical to that of the router 201, and the destination LDP identifier is made the same as that of the router 202. That is, the same packet as the packet received from the router 201 is transmitted to the router 202 (step S53).

The router 202 receives a packet containing the Label Request message, and then confirms that the destination LDP identifier points to itself to allocate the label. The allocation method as used herein accords with the label distribution protocol standards that are discussed by IETF.

The router 202 allocates an address to a desired FEC, and then transmits an LDP packet containing a Label Mapping message to the repeating installation 100. The packet header has described an LDP identifier of the router 202 of the transmitting source. As the destination LDP identifier, an LDP identifier of the router 201 that is a requester of the Label Request message is specified, and the Label Mapping message is embedded with a requested FEC and a label value allocated to the FEC (step S54).

The repeating installation 100 receives a Label Mapping message from the router 202, and then produces a label correspondence table 114 corresponding to the message (S55) The label correspondence table 114 contains the transfer class (FEC) and the label value, the LDP identifier of the router that has allocated this label, and the LDP ID of the router that has requested the Label Request, as shown in FIG. 3.

Further, the repeating installation 100 transmits an LDP packet containing the Label Mapping message to the router 201 of requester. Then, the packet header includes a description of an LDP identifier of the router 202 that has transmitted the Label Mapping message, with the destination LDP identifier being written with the LDP identifier of the router 201. That is, the same packet as the packet received from the router 202 is transmitted to the router 201 (step S56).

The router 201 receives the Label Mapping message, and then confirms that the destination LDP identifier is router 201 to register the allocated label in the label correspondence table. The storing of the label, and other operations, accord with the label distribution protocol standards discussed by IETF.

(2) Label merge operation

FIG. 6 shows the operation wherein in the label correspondence table 114 of the repeating installation as shown in FIG. 5, it is determined from the destination LDP identifier that a label has been already allocated to an FEC requested for the label allocation. FIG. 6 shows another example of the label distribution procedure in the embodiment of the invention.

Referring now to FIG. 11, the label merge operation will be briefly described below. In the case where the label distribution repeating installation of the invention receives a label allocating request including the allocation LDP identifier information of the router 202, and having a transfer class 2.2.2.0/24, it does not matter whether the transmission source is the router 201 or the router 203, as seen from the standpoint of the router 202, and the label allocating request may be transferred to the transfer destination in the same direction path. Accordingly, there is no need of distinguishing the processes for packets having the transfer class transmitted from the router 201 and the router 203, and it is more efficient to input them using the same label.

In FIG. 6, consider a case where the router 203 makes a request for label allocation corresponding to a certain FEC to the router 202. The repeating installation 100 receives a Label Request message from the router 203 (step S61), and then references the label correspondence table 114 to confirm that the router 202 has already allocated the label to this FEC. If it is determined that the same label is usable, an LDP identifier of the router 203 is added to the allocation destination ID column of the label correspondence table 114 to indicate that this label/FEC value has been allocated to the router 203 (label merge process; step S62).

The repeating installation 100 notifies the label obtained from the label correspondence table 114 to the router 203, using a Label Mapping message (step S63). In this case, the LDP identifier in the LDP header of the Label Mapping message is made the router 202.

In the case where the downstream router has already allocated the label, the label merge operation is effected to solve an allocating request using the already set label to the label for the same FEC. In this way, the label distribution repeating installation can reduce the label management process, using the same label for a label allocating request having the same FEC and destination LDP ID (this is called a label merge).

In this way, the transfer packet is transferred using the same path in that route by merging the label, but in a node at the branch of the path, the packet may be transferred with a new label appended thereto by referring to the information of Layer 3, thereby enabling the partial merge operation of label.

(3) Label release operation

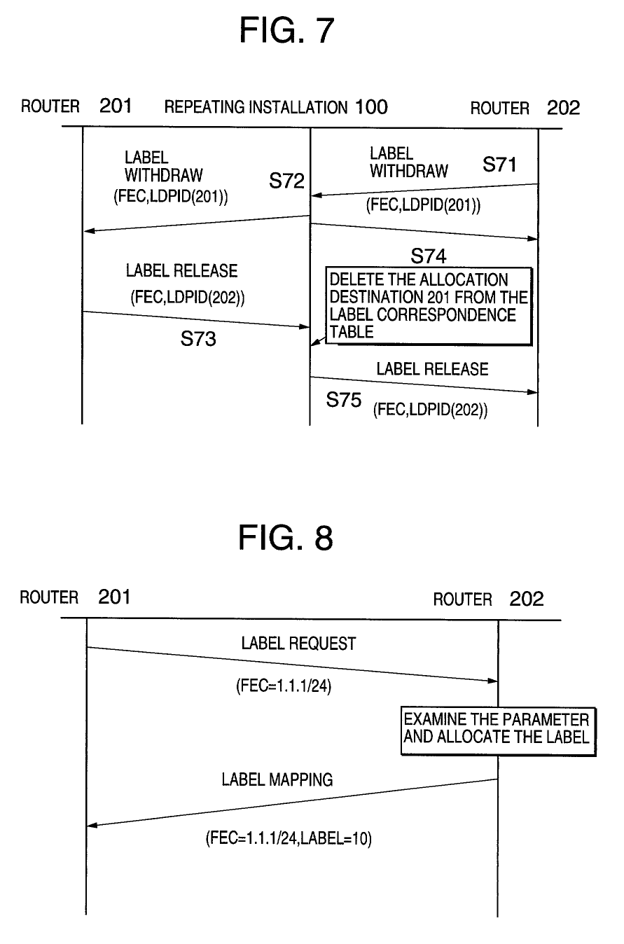

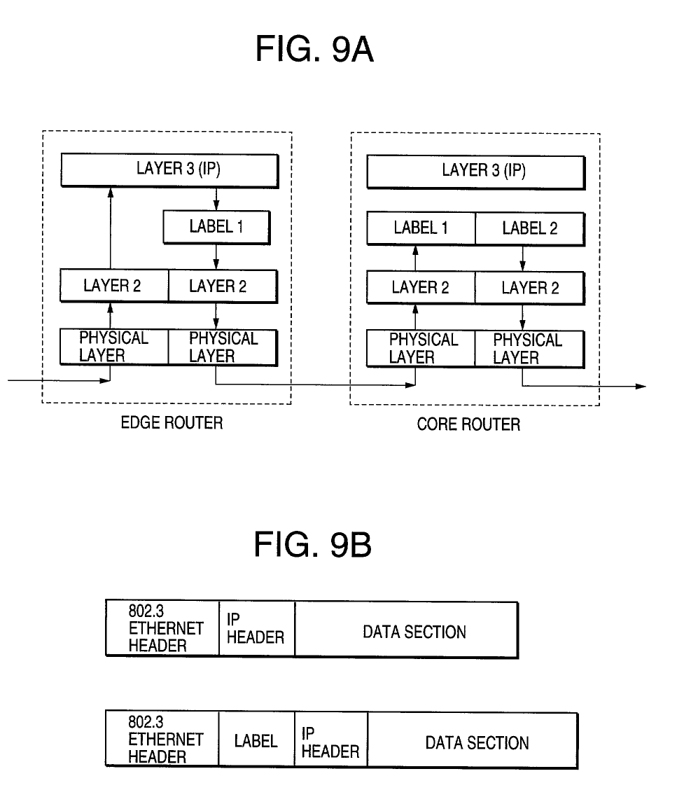

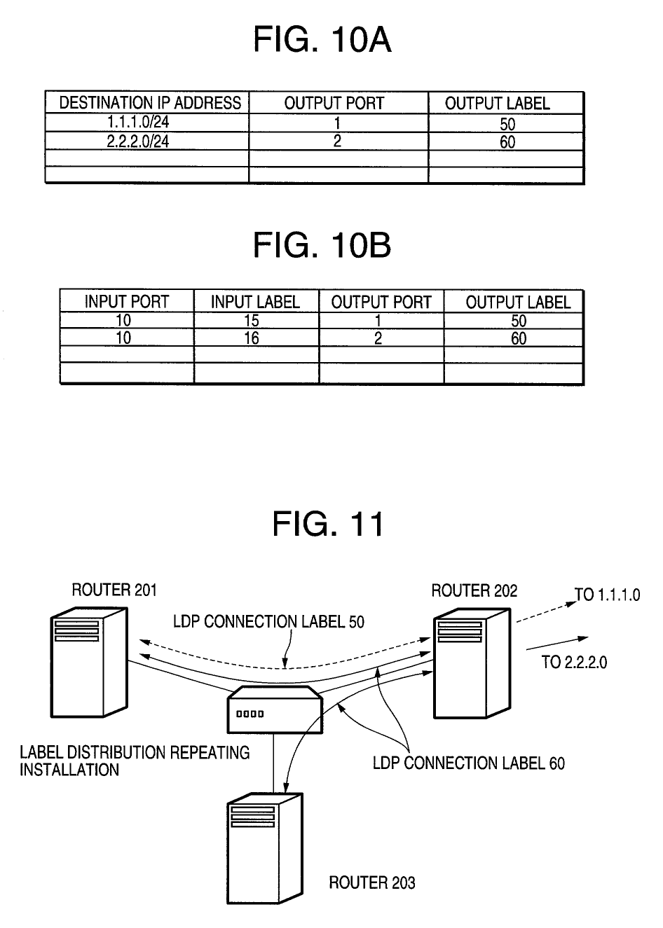

Referring now to FIG. 7, the label release operation will be described below. FIG. 7 shows an example of the label release operation in the embodiment of the invention. The label release operation involves a Label Release message from the upstream router 201 to the downstream router 202, and a Label Withdraw message from the downstream router 202 to the upstream router 201.

If a Label Withdraw message is received from the router 202 (step S71), the repeating installation 100 transfers this message to the router 201 designated by the destination LDP identifier (step S72). The router 201 receives this message, and then replies with the Label Release message to the router 202 (step S73).

The operation in which the router 201 transmits a Label Release message to the router 202 will be described below. If a Label Release message is received from the router 201, the repeating installation 100 checks the label correspondence table to delete the allocation destination LDP identifier corresponding to the FEC to be released (step S74). At this time, when there is no entry of the allocation destination LDP identifier, it is indicated that the label user does not exist. Hence, the Label Release message is transmitted to the router 202, and an entry corresponding to the FEC and the allocation destination LDP identifier is deleted (step S75).

Other embodiments of the Invention

In the previous embodiment as shown in FIG. 2, the label distribution repeating installation is placed independently. This function can be incorporated into one label switching router. In this case, the label switching router having a label distribution repeating function results. That is, the label distribution repeating function may be provided in a specific or arbitrary label switching router in accordance with the configuration of network. Thus, in the case where it is expected that a great number of communication nodes are connected to the network and the LDP processing load is larger, a connection for exchange of label information is set up between a label switching router having such label distribution repeating function and each router, to decentralize the label allocating process over the network, resulting in more efficient label switching operation.

With a label distribution method that employs a label distribution repeating installation according to the present invention, a connection may be only established between each label switching router and the label distribution repeating installation. Therefore, it is possible to reduce the number of connection pairs (or pairings) of the label distribution protocol established between the label switching routers in the conventional method, and decrease the load of each router.

In the case where a label allocating request capable of the label merge is issued from the upstream router, the repeating installation judges the label allocation, and does not issue a request to the downstream router, resulting in less processing load of the router.

What is claimed is:

1. A label distribution repeating installation for repeating transfer of label information between communication nodes for effecting label switching of an input packet in such a manner as to detect a packet flow to be grouped by a packet group having a same attribute received from a transmission path, and append an identifiable label to said packet flow, said label distribution repeating installation comprising:
units for receiving a label allocation request message from a former stage communication node, and then taking out destination information from said request message to repeat the transfer of the destination information to an allocated communication node;
units for receiving a label allocating response from said allocated communication node, and storing the label allocating response as label corresponding information for each destination information; and
units for receiving a label allocation request message that is self-allocable from said label corresponding information, and then performing a label allocating process directly to respond to a requesting communication node.

2. The label distribution repeating installation according to claim 1, further comprising units for receiving a label allocation request containing the same destination information as the already set label, and then allocating the already set label information to said request to make a notice to a requesting node.

3. In a communication network having a label switching router for effecting label switching of an input packet by reading information of an IP packet received from a transmission path, detecting a packet flow grouped by a packet group having the same destination information, and appending an identifiable label to said packet flow, a label distribution repeating installation comprising:
units for receiving a request message of allocating said label from a former stage router, and then taking out the destination information and transfer class information from said request message to repeat the transfer of the destination information and the transfer class information to a transfer destination router;
units for holding label allocating information with respect to said transfer destination router as a label correspondence table, and for a label allocation request message for the destination information of the already set label from the information stored in said label correspondence table, determining the possibility of allocating the same label;
units for making a label allocating process directly for the label allocation request message for which it is determined that the same label can be allocated, and responding with an allocating message to a requesting router.

4. The label distribution repeating installation according to claim 3, wherein said label correspondence table contains a transfer class of a packet flow to allocate the label, identification information for an interface of an allocation requesting node which is appended inherently, identification information for the interface of an allocated node, and the allocated label information.

5. The label distribution repeating installation according to claim 4, wherein said label allocation request contains a transfer class of a packet flow to allocate the label, identification information for the interface of an allocation requesting node which is appended inherently, and identification information for the interface of an allocated node.

6. The label distribution repeating installation according to claim 5, wherein said label distribution repeating installation has a connection for exchange of label information with each communication node for effecting the label switching.

7. The label distribution repeating installation according to claim 6, wherein said label distribution repeating installation has a connection for exchange of label information with each communication node for effecting the label switching, and holds the interface identification information of all the communication nodes connected adjacently.

8. A label distribution repeating installation for repeating the transfer of label information between communication nodes for performing the label switching of an input packet, by detecting a packet flow that is grouped by a packet group having the same attribute received from a transmission path, and appending an identifiable label to said packet flow, said label distribution repeating installation comprising:
line termination equipment for terminating a packet to be transmitted to take out packet data and make a transmission process; and
a repeating processor for performing a repeating transfer process of said packet from the packet data acquired from said line termination equipment;
wherein said repeating processor further comprises:
a protocol data unit (PDU) receiver for disassembling the packet data into message elements of a label distribution protocol;
a protocol analyzer for analyzing a message required for repeating from each message element;
a PDU transmitter for assembling the data to be retransmitted in accordance with the analysis of said message elements; and
a label correspondence table for storing LDP message information received.

9. A label distribution repeating method comprising the steps of:
establishing a connection for LDP communication between adjacent routers and exchanging a message; and
label handling for allocating labels using caching information of an allocation table for the already allocated label.

10. A label distribution repeating method according to claim 9, for use with a label distribution repeating installation for repeating transfer of label information between communication nodes for performing label switching of an input packet, by detecting a packet flow that is grouped by a packet group having the same attribute received from a transmission path, and appending an identifiable label to said packet flow, said label distribution repeating method comprising the steps of:
receiving a label allocation request message from a former stage communication node, and then taking out destination information from said message to repeat the transfer of the destination information to an allocated node;
receiving a label allocating response from said allocated communication node, and storing the label allocating response as label corresponding information for each destination information; and
receiving a label allocation request message that is self-allocable from said label corresponding information, and performing a label allocating process directly to respond to a requesting communication node.

11. A label distribution repeating installation comprising:
a message repeating function of repeating a connection with a router to which each router should establish a session; and
an agent allocation function of caching the allocation table information for the already allocated label.

12. A label distribution repeating installation according to claim 11, for repeating transfer of label information between communication nodes for effecting label switching of an input packet in such a manner as to detect a packet flow to be grouped by a packet group having a same attribute received from a transmission path, and append an identifiable label to said packet flow, said label distribution repeating installation comprising:
means for receiving a label allocation request message from a former stage communication node, and then taking out destination information from said request message to repeat the transfer of the destination information to an allocated communication node;
means for receiving a label allocating response from said allocated communication node, and storing the label allocating response as label corresponding information for each destination information; and
means for receiving a label allocation request message that is self-allocable from said label corresponding information, and then performing a label allocating process directly to respond to a requesting communication node.
